(19) United States
(12) Patent Application Publication
(10) Pub. No.: US 2025/0069441 A1
(43) Pub. Date: Feb. 27, 2025

(54) METHOD FOR MANAGING INFORMATION OF OBJECT AND APPARATUS PERFORMING SAME

(71) Applicant: HANWHAVISIONCO.,LTD., Seongnair-si (KR)

(72) Inventors: Byoung Man AN, Seongnaim-si (KR); Jin Hyuk CHOI, Seongnam-si (KR)

(73) Assignee: HANWHAVISIONCO.,LTD., Seongnair-si (KR)

(21) Appl. No.: 18/944,566

(22) Filed: Nov. 12, 2024

Related U.S. Application Data
(63) Continuation-in-part of application No. PCT/KR2023/006658, filed on May 15, 2023.

(30) Foreign Application Priority Data
May 17, 2022 (KR) 10-2022-0060288

(51) Int. Cl. G06V 40/20; G06V 10/74

(52) U.S. Cl. CPC G06V 40/20; G06V 10/761; G06V 2201/07

(57) ABSTRACT

Embodiments of the present disclosure relate to a method and apparatus for effectively managing a relationship between objects detected in images captured by a plurality of image capturing apparatuses. A method of managing an object detected by a plurality of image capturing apparatuses includes mapping positions of the plurality of image capturing apparatuses to generate mapping information, obtaining a first image from each of the plurality of image capturing apparatuses, detecting an object from the first image of each of the plurality of image capturing apparatuses, based on a first trained model, and storing the mapping information and connection information between detected objects.

### CROSS REFERENCE TO RELATED APPLICATIONS

This application is a Continuation in Part of International Application No. PCT/KR2023/006658, filed on May 17, 2023, which claims priority from Korean Patent Application No. 10-2022-0060288 filed on May 17, 2022, the disclosures of which are incorporated herein in their entireties by reference.

### TECHNICAL FIELD

Embodiments of the present disclosure relate to a method and apparatus for effectively managing a relationship between objects detected in images captured by a plurality of image capturing apparatuses.

### BACKGROUND ART

Today, image capturing apparatuses such as closed circuit televisions (CCTVs) or video surveillance devices are combined with technologies such as image processing using artificial neural networks to classify an object from an image and localize the object, and thus have been widely used for various purposes such as crime prevention, facility security, and workplace monitoring, etc., in private and public sectors.

The above-mentioned background technology is technical information that the inventor possessed for deriving the present disclosure or acquired in the process of deriving the present disclosure, and may not be necessarily said to be known art disclosed to the general public before filing the application of the present disclosure.

### DISCLOSURE

### Technical Problem

Embodiments of the present disclosure are proposed to solve the foregoing problems and provide a method and apparatus for effectively managing a relationship between objects detected in images captured by a plurality of image capturing apparatuses.

### Technical Solution

According to an embodiment of the present disclosure, a method of managing an object detected by a plurality of image capturing apparatuses includes mapping positions of the plurality of image capturing apparatuses to generate mapping information, obtaining a first image from each of the plurality of image capturing apparatuses, detecting an object from the first image of each of the plurality of image capturing apparatuses, based on a first trained model, and storing the mapping information and connection information between detected objects.

The generating of the mapping information may include estimating a distance between the plurality of image capturing apparatuses, based on a second trained model and estimating the map.

The estimating of the distance between the plurality of image capturing apparatuses based on the second trained model may include estimating the distance between the plurality of image capturing apparatuses based on the second trained model and estimating the map.

The estimating of the map may include correcting the map based on a type of the detected object, an object detection time, and the mapping information.

The storing of the connection information about the object may include extracting a third image, which is a partial image including an object of the same type as a type of an object of interest, from the first image obtained from each of the plurality of image capturing apparatuses, detecting behavior information about the object of the third image, based on the third image and a third trained model, and determining the connection information about the object of the third image, based on the behavior information.

The determining of the connection information may include determining the connection information based on the type of the object, a similarity of the behavior information, the object detection time, and the mapping information.

The connection information may include at least one of identification information regarding the object, image capturing apparatus information about an image capturing apparatus that detects the object among the plurality of image capturing apparatuses, and direction information about a direction in which the object deviates from the image capturing apparatus.

According to another embodiment of the present disclosure, an image processing apparatus includes a memory storing an image, information, and data and a processor configured to map positions of the plurality of image capturing apparatuses to generate mapping information, obtain a first image from each of the plurality of image capturing apparatuses, detect an object from the first image of each of the plurality of image capturing apparatuses, based on a first trained model, and store the mapping information and connection information between detected objects.

The processor may be further configured to estimate a distance between the plurality of image capturing apparatuses, based on a second trained model and estimate the map.

The processor may be further configured to identify, from the first image for each image capturing apparatus, a second image including another image capturing apparatus and estimate a distance between the plurality of image capturing apparatuses, based on the second image, size information about the plurality of image capturing apparatuses, and a second trained model.

The processor may be further configured to correct the map based on a type of the detected object, an object detection time, and the mapping information.

The processor may be further configured to extract a third image, which is a partial image including an object of the same type as a type of an object of interest, from the first image obtained from each of the plurality of image capturing apparatuses, detect behavior information about the object of the third image, based on the third image and a third trained model, and determine the connection information about the object of the third image, based on the behavior information.

The processor may be further configured to determine the connection information based on the type of the object, a similarity of the behavior information, the object detection time, and the mapping information.

The connection information may include at least one of identification information regarding the object, image capturing apparatus information about an image capturing apparatus that detects the object among the plurality of image capturing apparatuses, and direction information about a direction in which the object deviates from the image capturing apparatus.

### Advantageous Effects

According to an embodiment of the present disclosure, a relationship between objects detected in images captured by a plurality of image capturing apparatuses may be effectively managed and identified.

Effects of the embodiments are not limited to the effects mentioned above, and other effects not mentioned will be clearly understood by those of ordinary skill in the art from the detailed description and description of the claims.

### DESCRIPTION OF DRAWINGS

FIG. 1 schematically shows an image captured in a system for detecting an object by using a plurality of image capturing apparatuses.

FIG. 2 schematically shows a case where an image capturing apparatus according to an embodiment of the present disclosure is mapped onto a map.

FIG. 3 shows an example of object information generated by an image processing apparatus according to an embodiment of the present disclosure.

FIG. 4 shows an example of connection information of an object, generated by an image processing apparatus according to an embodiment of the present disclosure.

FIG. 5 schematically shows an image captured by an image capturing apparatus according to an embodiment of the present disclosure.

FIG. 6 is a flowchart schematically showing an operation performed by an image processing apparatus according to an embodiment of the present disclosure.

FIG. 7 is a flowchart schematically showing an operation, performed by an image processing apparatus, of generating mapping information according to an embodiment of the present disclosure.

FIG. 8 is a flowchart schematically showing an operation, performed by an image processing apparatus, of storing connection information according to an embodiment of the present disclosure.

FIG. 9 is a block diagram schematically showing an object management system according to an embodiment of the present disclosure.

FIG. 10 is a block diagram schematically showing an image capturing apparatus according to an embodiment of the present disclosure.

### MODE FOR INVENTION

The present disclosure may have various modifications thereto and various embodiments, and thus particular embodiments will be illustrated in the drawings and described in detail in a detailed description. Effects and features of the present disclosure, and methods for achieving them will become clear with reference to the embodiments described later in detail together with the drawings. However, the present disclosure is not limited to the embodiments disclosed below and may be implemented in various forms. Hereinafter, embodiments of the present disclosure will be described in detail with reference to the accompanying drawings, and in description with reference to the drawings, the same or corresponding components are given the same reference numerals, and redundant description thereto will be omitted.

In the following embodiments, the terms such as first, second, etc., have been used to distinguish one component from other components, rather than limiting.

In the following embodiments, singular forms include plural forms unless apparently indicated otherwise contextually.

In the following embodiments, the terms “include”, “have”, or the like, are intended to mean that there are features, or components, described herein, but do not preclude the possibility of adding one or more other features or components.

In the drawings, the size of components may be exaggerated or reduced for convenience of description. For example, since the size and thickness of each component shown in the drawings are arbitrarily shown for convenience of description, the disclosure is not necessarily limited to the illustrated bar.

In this case, the term ‘˜unit’ used in the current embodiment may refer to a component that performs specific functions performed by hardware such as software, a field programmable gate array (FPGA), or an application special circuit (ASC). However, ‘˜unit’ is not limited to execution by software or hardware. ‘˜unit’ may be present in the form of data stored in an addressable storage medium, or may be configured such that one or more processors execute certain functions.

Software may include a computer program, a code, an instruction, or a combination of one or more thereof, and may configure a processing device to operate as desired or independently or collectively instruct the processing device. The software and/or data may be permanently or temporarily embodied in any type of machine, component, physical device, virtual equipment, computer storage medium or device, or signal wave to be transmitted, so as to be interpreted by or to provide instructions or data to the processing device. The software may be distributed over computer systems connected through a network and may be stored or executed in a distributed manner. The software and data may be stored in one or more computer-readable recording media.

An ‘image’ according to the present disclosure may be a still image or a moving image including a plurality of consecutive frames.

A trained model or a network model according to the present disclosure may be a representative example of an artificial neural network model that simulates brain nerves, and is not limited to an artificial neural network model using a specific algorithm.

Object detection according to the present disclosure may refer to performing classification and localization for an image, and distance estimation or depth estimation may refer to estimating a distance to an object in an image with respect to image capturing equipment. Behavior detection may mean classifying a behavior of an object.

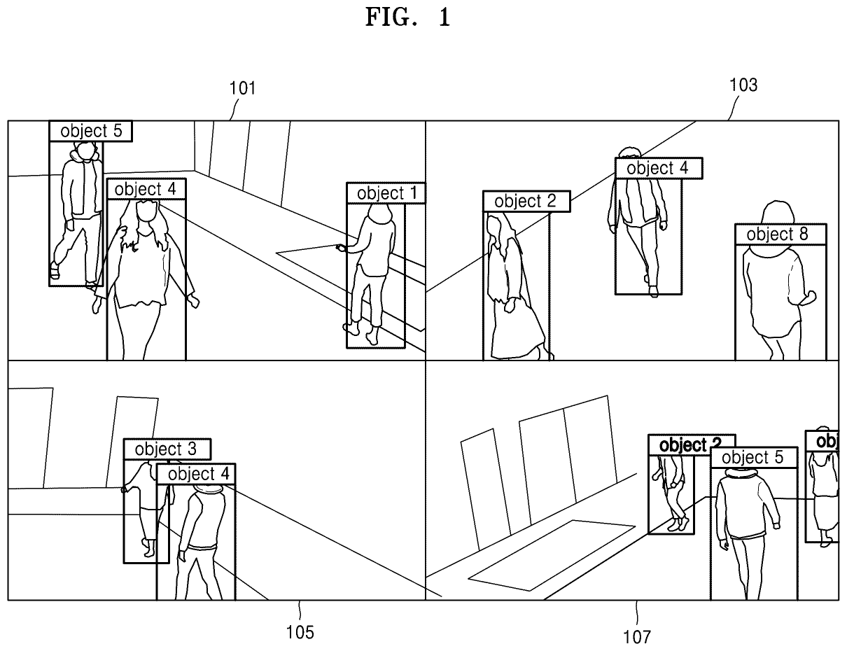

FIG. 1 schematically shows an image captured in a system for detecting an object by using a plurality of image capturing apparatuses. An object detection system according to an embodiment of the present disclosure may be a system that simultaneously manages multiple zones in parallel using a plurality of image capturing apparatuses beyond a system that captures an image of a specific zone by using one image capturing apparatuses.

Referring to FIG. 1, a first image 101, a second image 103, a third image 105, a fourth image 107, etc., may be obtained by a plurality of image capturing apparatuses.

The image processing apparatus according to an embodiment may perform object detection with respect to the first image 101, the second image 103, the third image 105, and the fourth image 107 based on a previously trained model, and extract information of an object for each image. The object detection system may detect an object for each image and perform separate processing to identify a relationship between objects detected for each image. For example, as shown in FIG. 1, an object 4 in the first image 101 and an object 2 in the second image 103 may be the same person, and the image processing apparatus may estimate identity between objects based on information of an object extracted for each image.

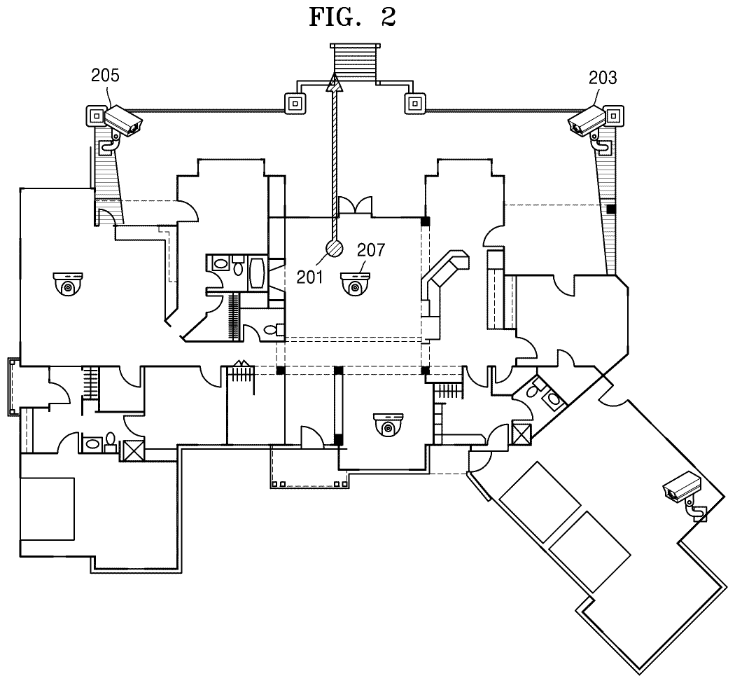

FIG. 2 schematically shows a case where an image capturing apparatus according to an embodiment of the present disclosure is mapped onto a map.

The image processing apparatus according to the present disclosure may map positions of the plurality of image processing apparatuses onto a map to generate mapping information. The mapping information may refer to three-dimensional (3D) coordinates at which the plurality of image capturing apparatuses are located on the map. The relative positions between the image capturing apparatuses may be identified from the mapping information. As shown in FIG. 2, for convenience of a description, it is shown that the image processing apparatus recognizes information about the map in advance, but the plurality of image capturing apparatuses may be mapped to the map estimated using the plurality of image capturing apparatuses as described below.

Referring to FIG. 2, when an object 201, for example, a person moves in an arrow direction, a plurality of image capturing apparatuses 203, 205, and 207 may capture a capturing zone for each of the plurality of image capturing apparatuses 203, 205, and 207 in parallel. The image processing apparatus may receive an image (hereinafter, a “first image”) captured in real time from each of the plurality of image capturing apparatuses 203, 205, and 207. The image processing apparatus may input the first image received from each of the image capturing apparatuses 203, 250, and 207 to the first trained model to detect the object 201 from the first image. While one object 201 is shown in FIG. 1, this is merely an example and a plurality of objects may be preset in a capturing zone and at least one object may be detected from the first image obtained from a defined capturing zone by each of the image capturing apparatuses 203, 205, and 207. The image processing apparatus may recognize that the object 201 detected in the first image captured by the plurality of image capturing apparatuses 203, 205, and 207 is a person and the same object.

The image processing apparatus may generate connection information of the object based on mapping information regarding the positions of the plurality of image capturing apparatuses 203, 205, and 207, and object information. The object information may include behavior (moving direction) information of an object, attribute information of the object, time information, etc.

For example, when the image processing apparatus recognizes the mapping information about the positions of the plurality of image capturing apparatuses 203, 205, and 207, the image processing apparatus may recognize that the first image capturing apparatus 203 and the second image capturing apparatus 205 have a relationship of facing each other and the third image capturing apparatus 207 is positioned between the first image capturing apparatus 203 and the second image capturing apparatus 205.

The image processing apparatus may identify a behavior of an object from a plurality of first images received from the plurality of image capturing apparatuses 203, 205, and 207. For example, the object 201 may move from a left end to a right end in the first image of the first image capturing apparatus 203, and the object 201 may move from the right end to the left end in the first image of the second image capturing apparatus 205, and the object 201 may move from a middle end to a top end in the first image of the third image capturing apparatus 207.

Based on a connection relationship between the relative positions of the image capturing apparatuses and a behavior of the object, the image processing apparatus may recognize that the object 201 detected in the first images obtained by the first image capturing apparatus 203, the second image capturing apparatus 205, and the third image capturing apparatus 207 is not only an object of the same type, but also the same object.

As described above, when the image capturing apparatus is mapped onto the map, the sameness or similarity of an object detected in each image capturing apparatus may be determined. Hereinbelow, a method and apparatus for mapping the image capturing apparatus onto the map will be proposed.

The image processing apparatus may use a global positioning system (GPS), a beacon, or other position information providing systems to map the positions of the image capturing apparatuses 203, 205, and 207 onto the map. The position information system may provide accurate position and direction information of the image capturing apparatuses to help the image processing apparatus accurately performing sameness or similarity determination with respect to an object.

The image processing apparatus may analyze the first images received from the plurality of image capturing apparatuses 203, 205, and 207 to identify characteristics of the object 201. The characteristics of the object may include an appearance, a color, a size, a behavior pattern, etc. Based on such characteristics of the object, the image processing apparatus may determine the sameness and similarity of the object 201 captured in the plurality of image capturing apparatuses 203, 205, and 207.

The image processing apparatus may track and predict a moving path of the object based on connection information of the object. In this way, the image processing apparatus may predict the moving path of the object 201 to optimize the behaviors of the image capturing apparatuses 203, 205, and 207. For example, when an object is predicted to leave a capturing zone of a specific image capturing apparatus, the image processing apparatus may previously activate another image capturing apparatus to guarantee continuous tracking of the object.

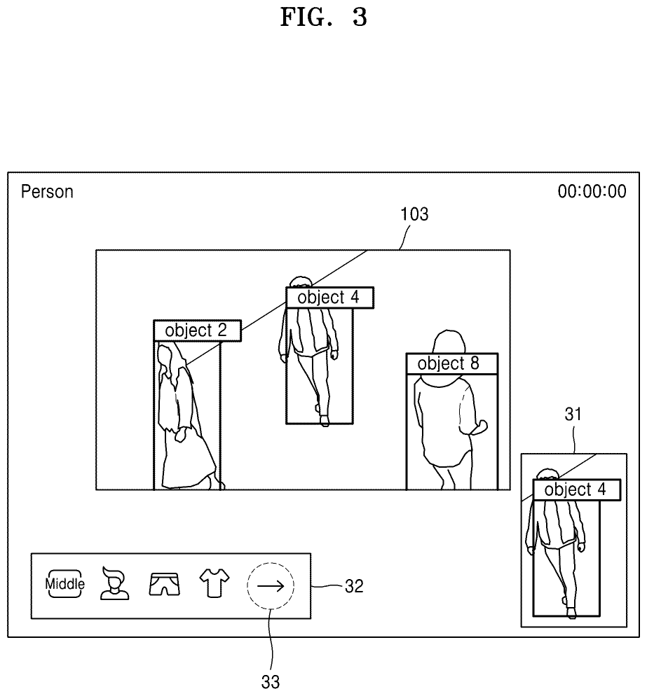

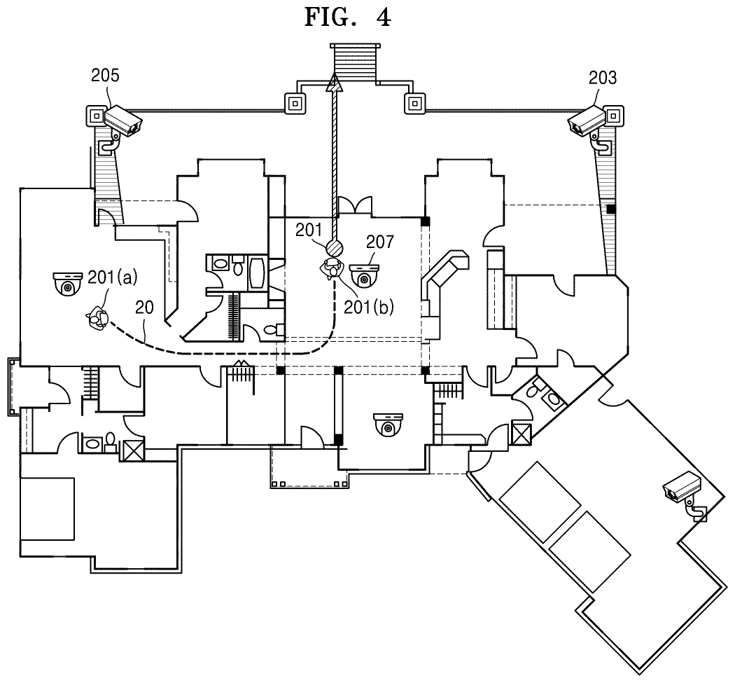

FIG. 3 shows an example of object information generated by an image processing apparatus according to an embodiment of the present disclosure. In addition, FIG. 4 shows an example of connection information of an object, generated by an image processing apparatus according to an embodiment of the present disclosure.

Referring to FIG. 3, an example is shown in which the image processing apparatus according to an embodiment of the present disclosure generates object information based on the second image 103 of FIG. 1.

The image processing apparatus may generate connection information of the object based on mapping information regarding the positions of the plurality of image capturing apparatuses 203, 205, and 207, and object information. The object information may include behavior (moving direction) information of an object, attribute information of the object, time information, etc.

For example, as shown in FIG. 3, the image processing apparatus according to an embodiment of the present disclosure may display an object attribute information user interface (UI) 32 and an object image 31 in a process of generating object information regarding an object 4. For example, the object attribute information UI 32 may include a moving direction UI 32 of the object. For example, the object moving direction UI 33 may display a total of 8 directions as the moving direction of the object.

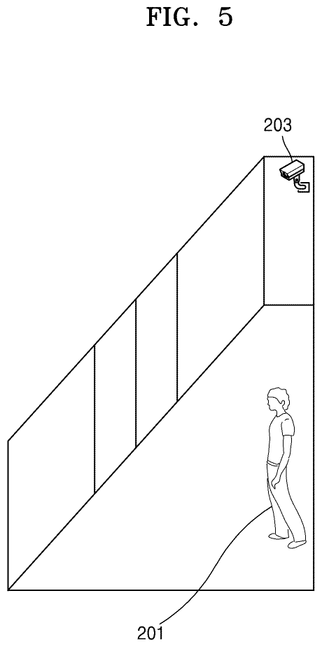

Referring to FIGS. 2 to 4 together, the image processing apparatus according to an embodiment of the present disclosure may display a tracking movement line 20 of the object 201 on the map. For example, as shown in FIG. 4, the image processing apparatus according to an embodiment of the present disclosure may display the tracking movement line 20 of the object 201 on the map. For example, the image processing apparatus according to an embodiment of the present disclosure may display the tracking movement line 20 from an initial position 201 (a) of the object 201 to a final position 201 (b). FIG. 5 schematically shows an image captured by an image capturing apparatus according to an embodiment of the present disclosure. Specifically, the image shown in FIG. 5 may be an image captured by the second image capturing apparatus 205 of FIG. 2.

The image processing apparatus may previously store setting information regarding performance, a size, and a lens of each of the plurality of image capturing apparatuses 203, 205, and 207. The image processing apparatus may estimate relationship information between the plurality of image capturing apparatuses 203, 205, and 207 or a distance between the plurality of image capturing apparatuses 203, 205, and 207 based on the setting information of the plurality of image capturing apparatuses 203, 205, and 207. The setting information may be a basis for accurately estimating a relationship and a distance between image capturing apparatuses. The image processing apparatus may consider photographing environment and condition of each image capturing apparatus by using the setting information.

The image processing apparatus may estimate relationship information between the plurality of image capturing apparatuses 203, 205, and 207 or a distance between the plurality of image capturing apparatuses 203, 205, and 207 based on the setting information of the plurality of image capturing apparatuses 203, 205, and 207. To this end, the image processing apparatus may analyze an image transmitted from each image capturing apparatus and identify an interaction between other image capturing apparatuses by using a detection technique.

A description will be made of a method, performed by an image processing apparatus, of generating relationship information between the plurality of image capturing apparatuses 203, 205, and 207. The image processing apparatus may first determine whether, from a series of images input from a certain image capturing apparatus, another image capturing apparatus is detected. Specifically, it may be determined by object detection whether in each of a plurality of images received from the plurality of image capturing apparatuses 203, 205, and 207, an image (hereinafter, referred to as a “second image”) captured by another image capturing apparatus is present. For example, as shown in FIG. 5, the image processing apparatus may detect the first image capturing apparatus 203 from the second image captured by the second image capturing apparatus 205.

In this way, the image processing apparatus may recognize a relationship between image capturing apparatuses and establish a temporal and spatial relationship between images based on the recognized relationship.

The image processing apparatus may analyze a relationship between images captured by an image capturing apparatus and other image capturing apparatuses to estimate a distance between the image capturing apparatus and another image capturing apparatus. To this end, the image processing apparatus may analyze a spatial relationship between images by using distance estimation or depth estimation techniques. In this way, the image processing apparatus may derive accurate distance and position information between the plurality of image capturing apparatuses 203, 205, and 207.

When in a plurality of images captured by a certain image capturing apparatus, another image capturing apparatus is detected, the image processing apparatus may estimate which one of the plurality of image capturing apparatuses 203, 205, 207 is the other image capturing apparatus detected in the second image captured by the certain image capturing apparatus, based on a frequency of an object of the same type being captured in the same capturing time zone and a moving direction of the object, in the second images captured by the plurality of image capturing apparatuses 203, 205, and 207. For example, when the object 201 of the same type is continuously detected in the same time zone in the image captured by the second image capturing apparatus 205 and the image captured by the first image capturing apparatus 203, the image processing apparatus may estimate that an image capturing apparatus in the second image captured by the second image capturing apparatus 205 is the first image capturing apparatus 203.

When in an image captured by a certain image capturing apparatus, another image capturing apparatus is detected, the image processing apparatus may estimate a distance between the certain image capturing apparatus and the other image capturing apparatus. Specifically, the image processing apparatus may estimate a distance of each pixel with respect to the image capturing apparatus through distance estimation or depth estimation. Specifically, the image processing apparatus may input a second image in which another image capturing apparatus is detected in an image captured by a certain image capturing apparatus to a second trained model to perform depth estimation for the second image and estimate a distance between the certain image capturing apparatus and the other image capturing apparatus. For example, the image processing apparatus may estimate a distance to the first image capturing apparatus 203 in the second image captured by the second image capturing apparatus 205. The image processing apparatus may also previously train the second trained model by considering setting information about performance, sizes, and lenses of the plurality of image capturing apparatuses 203, 205, and 207. Such an image processing apparatus may input the second image and the setting information to the second trained model to estimate the distance between the certain image capturing apparatus and the other image capturing apparatus.

According to an embodiment of the present disclosure, when in an image captured by a certain image capturing apparatus, another image capturing apparatus is not detected, the image processing apparatus may estimate a relationship between the plurality of image capturing apparatuses 203, 205, and 207 based on a frequency of an object of the same type, obtained in the first images captured by the plurality of image capturing apparatuses 203, 205, and 207, being captured in the same capturing time zone and a moving direction of the object.

The image processing apparatus may estimate relationship information between the plurality of image capturing apparatuses 203, 205, and 207 or a distance between the plurality of image capturing apparatuses 203, 205, and 207 based on the setting information of the plurality of image capturing apparatuses 203, 205, and 207, and estimate a map based on the estimated relationship information or distance. The image processing apparatus may generate the map or combine the map with existing map information based on the estimated distance or relationship information. The image processing apparatus may map the plurality of image capturing apparatuses 203, 205, and 207 onto the estimated map.

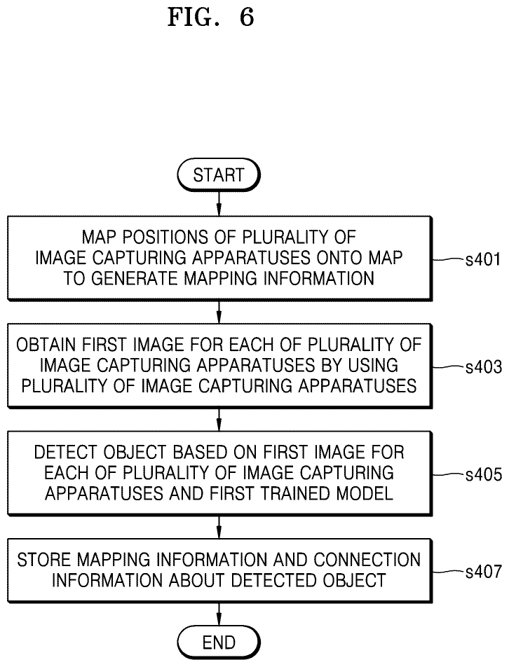

FIG. 6 is a flowchart schematically showing an operation performed by an image processing apparatus according to an embodiment of the present disclosure.

Referring to FIG. 6, the image processing apparatus may map positions of the plurality of image processing apparatuses onto a map to generate mapping information, in operation S401. For example, the image processing apparatus may estimate relationship information between a plurality of image capturing apparatuses. The image processing apparatus may estimate a map based on the relationship information between the plurality of image capturing apparatuses, and map positions of the plurality of image capturing apparatuses onto the estimated map.

The image processing apparatus may obtain a first image for each image capturing apparatus by using the plurality of image capturing apparatuses, in operation S403. The plurality of image capturing apparatuses may transmit the first images captured in real time to the image processing apparatus which may receive the first image from each of the plurality of image capturing apparatuses.

The image processing apparatus may detect an object based on the first image for each image capturing apparatus and a first trained model, in operation S405. The image processing apparatus may input the first images received in real time from the plurality of image capturing apparatuses to the first trained model regarding object detection to detect the object from the first images.

The image processing apparatus may store mapping information and connection information regarding the detected object, in operation S407. The connection information may indicate the sameness of the object detected in the first image for each image capturing apparatus. The image processing apparatus may extract a partial image (hereinbelow, a ‘third image’) including the detected object from the first image. The image processing apparatus may input the third image to a pre-trained third model to identify behavior information of the object. The behavior information, which is information about a behavior of the object, may be obtained by an algorithm based on, for example, at least one of motion detection, object tracking, pose estimation, and action recognition. For example, the behavior information may indicate information about a moving path of the object, a pattern of motion, a behavior pattern, a pose, and an action. The image processing apparatus may estimate that the objects are the same when behavior information of the objects in the third images obtained from different image capturing apparatuses, types of the objects are the same, and the objects are captured in the same time zone.

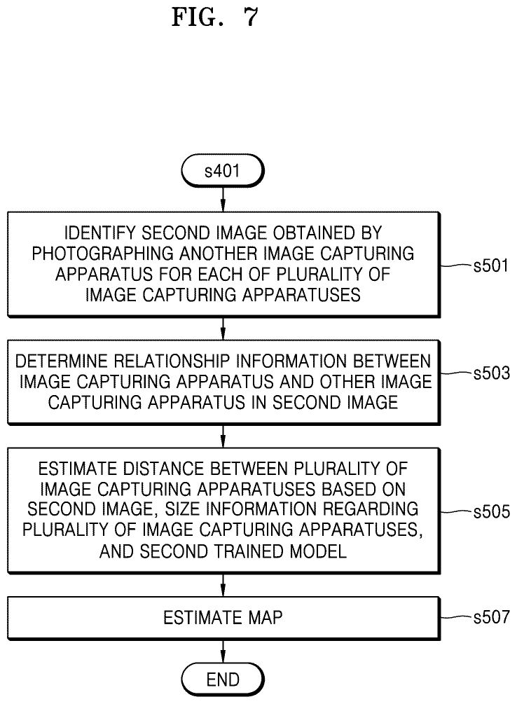

FIG. 7 is a flowchart schematically showing an operation, performed by the image processing apparatus, of generating mapping information according to an embodiment of the present disclosure, and FIG. 7 corresponds to a feature of the image processing apparatus operating in operation S401.

Referring to FIG. 7, in operation S501, the image processing apparatus may obtain a second image obtained by photographing another image capturing apparatus for each image capturing apparatus. For example, the image processing apparatus may identify, as the second image, an image in which in an image captured by one of the plurality of image capturing apparatuses, the other image capturing apparatus is detected.

In operation S503, the image processing apparatus may determine relationship information between the image capturing apparatus and the other image capturing apparatus in the second image. Herein, the relationship information may be relative position information between the image capturing apparatuses. Specifically, when in an image captured by an image capturing apparatus, the other image capturing apparatus is detected, the image processing apparatus may estimate which one of the plurality of image capturing apparatuses is the other image capturing apparatus detected in the second image captured by the image capturing apparatus, based on a frequency of the objects of the same type being captured in the same time zone, and a moving direction of the object in the second image captured by each of the plurality of image capturing apparatuses. For example, when the objects of the same type are continuously detected in the same time zone from the first images of the second image capturing apparatus and the first image capturing apparatus, the image processing apparatus may estimate that the image capturing apparatus in the second image captured by the second image capturing apparatus is the first image capturing apparatus.

According to an embodiment of the present disclosure, even when in an image captured by an image capturing apparatus, the other image capturing apparatus is not detected, a relationship between the plurality of image capturing apparatuses may be estimated based on a frequency of the objects of the same type being captured in the same capturing time zone and a moving direction of the object.

The image processing apparatus may estimate a distance between the plurality of image capturing apparatuses, based on the second image and the second trained model, in operation S505. Specifically, the image processing apparatus may perform in advance training of the second trained model based on setting information regarding performance, sizes, and lenses of the plurality of image capturing apparatuses and input the second image and the setting information to the pre-trained second trained model to estimate a distance between the image capturing apparatus and the other image capturing apparatus.

The image processing apparatus may estimate the distance between the plurality of image capturing apparatuses, based on the relationship information between the plurality of image capturing apparatuses, estimated based on the setting information of the plurality of image capturing apparatuses, the second image, and the second trained model, in operations S503 and S505.

In operation S507, the image processing apparatus may estimate the map based on the estimated relationship information between the plurality of image capturing apparatuses and the estimated distance information between the plurality of image capturing apparatuses, and map the plurality of image capturing apparatuses to the estimated map to generate mapping information.

The image processing apparatus may correct the map based on the type of the detected object, an object detection time, and the mapping information.

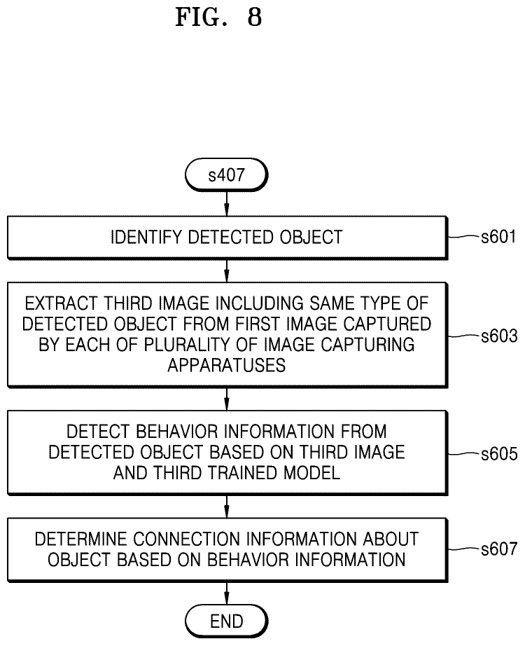

FIG. 8 is a flowchart schematically showing an operation, performed by the image processing apparatus, of generating connection information according to an embodiment of the present disclosure, and FIG. 8 corresponds to a feature of the image processing apparatus operating in operation S407.

In operation S601, the image processing apparatus may identify the detected object. Specifically, the image processing apparatus may classify the type of the detected object based on the first image for each image capturing apparatus and the first trained model, and identify the position of the detected object.

In operation S603, the image processing apparatus may extract a third image of each object of the same type from the first images captured from the plurality of image capturing apparatuses. For example, when a person is an object of interest, third images regarding all objects classified as persons among the objects detected in the first image may be extracted.

In operation S605, the image processing apparatus may detect behavior information from the detected object, based on the third image and the third trained model. Specifically, the image processing apparatus may input the third image to the third trained model as a trained model for detecting the behavior information to obtain the behavior information of the object in the third image.

The image processing apparatus may determine connection information regarding the object based on the behavior information, in operation S607. The image processing apparatus may determine connection information of the object based on a type of the object, a moving direction of the object, a similarity of behavior information, an object detection time, and mapping information. The image processing apparatus may estimate the objects of the same type as having the sameness when they have behaviors of the same type in the same time zone. The connection information may include information about the objects estimated as having the sameness and additional information for facilitating tracking of the objects.

Table 1 shows an example of connection information between objects detected in different image capturing apparatuses, generated by the image processing apparatus and stored in a storage means.

TABLE 1

| Image | | | | | | |
|---|---|---|---|---|---|---|
| Capturing | | | Image Capturing | | | Connection |
| Apparatus | ObjectID | Time | Apparatus | ObjectID | Time | or No-Connection |
| Cam A | 1 | hh-mm-ss | Cam B | 2 | hh-mm-ss | Y |

For example, Table 1 shows connection information regarding a connection relationship indicating that an object with Object ID 1, photographed and recognized in Cam A, and an object with Object ID 2, photographed and recognized in Cam B, have the sameness (or are the same as or similar to each other).

The connection information may include at least one of attribute information including a color, a size, etc., of an object, detection capturing apparatus information about an image capturing apparatus detecting an object among the plurality of image capturing apparatuses, and a moving direction (information about a direction in which an object appears, information about a direction in which an object deviates, etc.) of an object in the detection image capturing apparatus.

Referring to FIGS. 6 to 8, the image processing apparatus may perform relatively simple object detection on the first image captured in real time to speed up processing, extract a third image of the same type detected in the first image, analyze the sameness or similarity between objects detected in the first images obtained from different image capturing apparatuses through behavior detection with respect to the third image, and store corresponding data, thereby performing efficient object management.

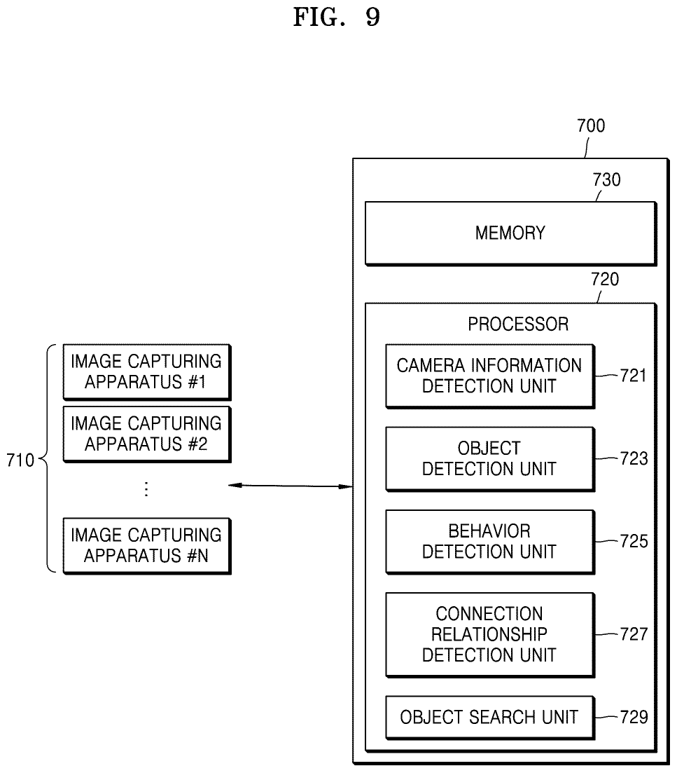

FIG. 9 is a block diagram schematically showing an object management system according to an embodiment of the present disclosure.

The object management system may be implemented by a plurality of image capturing apparatuses 710 and an image processing apparatus 700. The image processing apparatus 700 is shown as including a memory 730 and a processor 720, but the present disclosure is not limited thereto. For example, the plurality of image processing apparatuses 710, the image processing apparatus 700, the memory 730, and the processor 720 in the object management system each may be one physically independent component or may be implemented as a separate computer device including the memory 730 and the processor 720.

The image capturing apparatuses 710 may be connected to the image processing apparatus 700 through a wired and/or wireless network.

The image capturing apparatuses 710 may include a surveillance camera, such as a visual camera, a thermal image camera, a general-purpose camera, etc. Each of the plurality of image capturing apparatuses 710 may capture an image regarding a management zone set in an installation position thereof and transmit the image to the image processing apparatus 700. For example, each of the plurality of image capturing apparatuses 710 may transmit the first image captured in real time to the image processing apparatus 700. The image capturing apparatus 710 may also perform behaviors performed by an object detection unit 723 and a behavior detection unit 723 of the image processing apparatus 700 described below and transmit information about a type, a position, and a behavior of the detected object to the image processing apparatus 700.

The image processing apparatus 700 may include a storage device such as a digital video recorder (DVR), a network video recorder (NVR), etc., a video management system (VMS), and so forth.

The memory 730 may be an internal storage device that stores an image, information, and data. For example, the memory 730 may store a first image, a second image, and a third image. The memory 730 may store setting information, behavior information, connection information, direction information, mapping information, distance information, and relationship information. In an embodiment, the image processing apparatus 700 may store an image, information, and data in an external storage device connected through a network. The memory 730 may include a camera information detection unit 721, an object detection unit 723, a behavior detection unit 725, a connection relationship detection unit 727, and an object search unit 729 as computer-readable storage media.

The processor 720 may be implemented with various numbers of hardware and/or software configurations executing particular functions. For example, the processor 720 may mean, for example, a data processing device embedded in hardware, which has a physically structured circuit to perform a function represented as a code or a command included in a program. Examples of the data processing device embedded in hardware may include a microprocessor, a CPU, a processor core, a multiprocessor, an ASIC, an FPGA, and so forth, but the scope of the present disclosure is not limited thereto.

The processor 720 may control an overall operation of the image processing apparatus 700 according to an embodiment of the present disclosure. For example, the processor 720 may control the image processing apparatus 700 to perform operations in FIGS. 6 to 8.

For example, the processor 720 may map positions of the plurality of image capturing apparatuses onto the map to generate mapping information, obtain the first image in real time from each of the plurality of image capturing apparatuses, detect an object based on the first image for each image capturing apparatus and the first trained model, and store the mapping information and connection information regarding the detected object.

The processor 720 may include the camera information detection unit 721, the object detection unit 723, the behavior detection unit 725, the connection relationship detection unit 727, and the object search unit 729

The camera information detection unit 721 may determine relationship information between an image capturing apparatus and another image capturing apparatus in the second image. The camera information detection unit 721 may perform in advance training of the second trained model based on setting information regarding performance, sizes, and lenses of the plurality of image capturing apparatuses and input the second image and the setting information to the pre-trained second trained model to estimate a distance between the image capturing apparatus and the other image capturing apparatus.

The camera information detection unit 721 may estimate the map based on the estimated relationship information between the plurality of image capturing apparatuses and the estimated distance information between the plurality of image capturing apparatuses, and map the plurality of image capturing apparatuses to the estimated map to generate mapping information.

The camera information detection unit 721 may obtain performance information of each of the plurality of image capturing apparatuses 710. For example, the camera information detection unit 721 may obtain information about a viewing angle and a focal distance of each of the plurality of image capturing apparatuses 710. The camera information detection unit 721 may normalize images obtained from the plurality of image capturing apparatuses 710 by using the performance information of each of the plurality of image capturing apparatuses 710.

The object detection unit 723 may detect the object based on the first image and the first trained model. The object detection unit 723 may identify the type and the position of the detected object. For example, the object detection unit 723 may detect the object by using an algorithm such as R-CNN, Fast R-CNN, Faster R-CNN, YOLO, and SSD.

The behavior detection unit 725 may extract a third image of an object of the same type as the type of an object of interest from the first image and detect behavior information of the object based on the third image and the third trained model. For example, the behavior detection unit 725 may detect the behavior information of the object by using an algorithm such as 3D CNN, LSTM, Two-Stream Convolutional Networks, I3D, and Timeception.

The connection relationship detection unit 727 may determine connection information of the object based on a type of the object, a moving direction of the object a similarity of behavior information, an object detection time, and mapping information. The connection information include at least one of attribute information (identification information) about an object, image capturing apparatus information about an image capturing apparatus that detects an object among the plurality of image capturing apparatuses, and moving direction information of an object (direction information about a direction in which an object appears, direction information about a direction in which an object deviates, etc.).

The object search unit 729 may search for an object by using the type of an object, a similarity of behavior information, an object detection time, and mapping information as attributes and connection information as a criterion for the sameness. For example, the object search unit 729 may regard objects interconnected (linked) by the connection information as the same objects and return information related to the objects to a user.

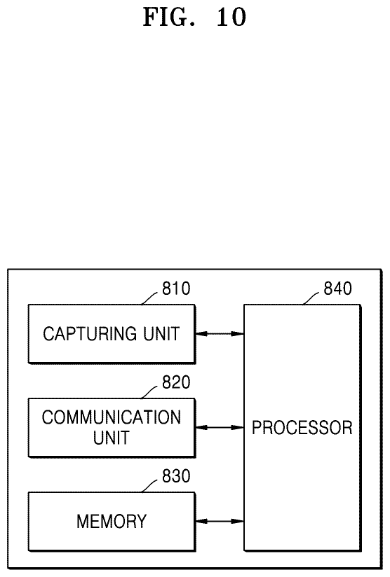

FIG. 10 is a block diagram schematically showing an image capturing apparatus according to an embodiment of the present disclosure.

Referring to FIG. 10, an image capturing apparatus may include a capturing unit 810, a communication unit 820, a memory 830, and a processor 840. However, all the illustrated components are not essential components. The image capturing apparatus may be implemented by more or less components than the illustrated components. Hereinafter, the components will be described.

The capturing unit 810 may continuously capture an image using an image sensor, etc.

The communication unit 820 may be wiredly or wirelessly connected to a network to communicate with an external device. Herein, the external device may be an image processing apparatus. The communication unit 820 may transmit data to an image processing apparatus or may be connected to the image processing apparatus to receive services or contents provided by the server 101.

The memory 830 may store software or a program. For example, the memory 830 may store at least one program related to the operations of the image capturing apparatus described with reference to FIGS. 1 to 9. The memory 830 may be one of random access memories (RAMs), non-volatile memories including flash memories, read only memories (ROMs), electrically erasable programmable ROMs (EEPROMs), magnetic disc storage devices, compact disc-ROMs (CD-ROMs), digital versatile discs (DVDs), other types of optical storage devices, or magnetic cassettes.

The processor 840 may execute a program stored in the memory 830, read data or a file stored in the memory 830, or store a new file in the memory 830. The processor 840 may execute instructions stored in the memory 830.

The processor 840 according to an embodiment may detect an object from a first image based on a first trained model to detect object information, detect object-specific behavior information, transmit object information and behavior information to the image processing apparatus, and receive connection information determined based on the object information and the behavior information from the image processing apparatus.

The processor 840 according to an embodiment may estimate, based on a second trained model, a distance between the image capturing apparatus and another image capturing apparatus from a second image in which the other image capturing apparatus is included in the first image, and transmit the distance to the image processing apparatus.

By simultaneously managing images captured by a plurality of image capturing apparatuses, the size of data to be processed in a management system may increase significantly, and a delay in an image processing process may be a problem. Moreover, a relationship between objects detected in respective images of the plurality of image capturing apparatuses may be unclear. An object detection system according to an embodiment of the present disclosure determine, based on object behavior information, such as relative installation positions between image capturing apparatuses and moving directions of the objects detected in the images captured in real time by the image capturing apparatuses, sameness and similarity between objects detected by different image capturing apparatuses and interconnect (link) them, thereby interconnecting (linking) attribute information of the respective objects and improving storage efficiency and similar object search efficiency to enable efficient data processing.

Although the present disclosure has been described with respect to the preferred embodiments mentioned above, it is possible to make various modifications and variations without departing from the spirit and scope of the present disclosure. Accordingly, the appended claims may include such modifications or variations as long as they fall within the spirit of the present disclosure.

1. A method of managing an object detected by a plurality of image capturing apparatuses, the method comprising:
mapping positions of the plurality of image capturing apparatuses to generate mapping information;
obtaining a first image from each of the plurality of image capturing apparatuses;
detecting an object from the first image of each of the plurality of image capturing apparatuses, based on a first trained model; and
storing the mapping information and connection information between detected objects.

2. The method of claim 1, wherein the generating of the mapping information comprises:
identifying, from the first image of each of the plurality of image capturing apparatuses, a second image comprising another image capturing apparatus;
estimating a distance between the plurality of image capturing apparatuses, based on the second image, size information about the plurality of image capturing apparatuses, and a second trained model; and
correcting the map based on a type of the detected object, an object detection time, and the mapping information to estimate the map.

3. The method of claim 1, wherein the storing of the connection information about the object comprises:
extracting a third image, which is a partial image comprising an object of a same type as a type of an object of interest, from the first image obtained from each of the plurality of image capturing apparatuses;
detecting behavior information about the object of the third image, based on the third image and a third trained model; and
determining the connection information about the object of the third image, based on the behavior information.

4. The method of claim 3, wherein the determining of the connection information comprises determining the connection information based on the type of the object, a similarity of the behavior information, the object detection time, and the mapping information.

5. The method of claim 1, wherein the connection information comprises at least one of identification information regarding the object, image capturing apparatus information about an image capturing apparatus that detects the object among the plurality of image capturing apparatuses, and direction information about a direction in which the object deviates from the image capturing apparatus.

6. The method of claim 1, further comprising normalizing the first image based on performance information of each of the plurality of image capturing apparatuses.

7. An image processing apparatus comprising:
a memory storing an image, information, and data; and
a processor configured to map positions of the plurality of image capturing apparatuses to generate mapping information, obtain a first image from each of the plurality of image capturing apparatuses, detect an object from the first image of each of the plurality of image capturing apparatuses, based on a first trained model, and store the mapping information and connection information between detected objects.

8. The image processing apparatus of claim 7, wherein the processor is further configured to identify, from the first image of each of the plurality of image capturing apparatuses, a second image comprising another image capturing apparatus, estimate a distance between the plurality of image capturing apparatuses, based on the second image, size information about the plurality of image capturing apparatuses, and a second trained model, and correct the map based on a type of the detected object, an object detection time, and the mapping information to estimate the map.

9. The image processing apparatus of claim 7, wherein the processor is further configured to extract a third image, which is a partial image comprising an object of a same type as a type of an object of interest, from the first image obtained from each of the plurality of image capturing apparatuses, detect behavior information about the object of the third image, based on the third image and a third trained model, and determine the connection information about the object of the third image, based on the behavior information.

10. The image processing apparatus of claim 7, wherein the processor is further configured to determine the connection information based on the type of the object, a similarity of the behavior information, the object detection time, and the mapping information.

11. The image processing apparatus of claim 7, wherein the connection information comprises at least one of identification information regarding the object, image capturing apparatus information about an image capturing apparatus that detects the object among the plurality of image capturing apparatuses, and direction information about a direction in which the object deviates from the image capturing apparatus.

12. The image processing apparatus of claim 7, wherein the processor is further configured to normalize the first image based on performance information of each of the plurality of image capturing apparatuses.

13. An image capturing apparatus comprising:
a communication unit configured to transmit and receive data to and from an image processing apparatus; and
a processor configured to detect an object from a first image based on a first trained model to detect object information, detect behavior information for each object, transmit the object information and the behavior information to the image processing apparatus, and receive connection information, determined based on the object information and the behavior information, from the image processing apparatus.

14. The image capturing apparatus of claim 13, wherein the processor is further configured to estimate, from a second image comprising another image capturing apparatus in the first image, a distance between the image capturing apparatus and the other image capturing apparatus based on a second trained model and transmit the distance to the image processing apparatus.

15. A computer-readable recording medium having stored therein instructions executable by a processor, the processor comprising:
an object detection unit configured to a first image from each of a plurality of image capturing apparatuses and detect an object from the first image of each of the plurality of image capturing apparatuses, based on a first trained model;
a camera information detection unit configured to identify a second image comprising another image capturing apparatus in the first image for each of the plurality of image capturing apparatuses, estimate a distance between the plurality of image capturing apparatuses based on the second image, size information regarding the plurality of image capturing apparatuses, and a second trained model, and generate mapping information;
a behavior detection unit configured to extract a third image of an object of a same type as a type of an object of interest from the first image and detect behavior information of the object based on a third image and a third trained model; and
a connection relationship detection unit configured to determine connection information of the object based on a type of the detected object, the mapping information, and the behavior information.
